(19) United States
(12) Patent Application Publication
(10) Pub. No.: US 2025/0162478 A1
(43) Pub. Date: May 22, 2025

(54) VEHICLE SEAT MAT WITH FOOTREST STEP UP FEATURE FOR SAFETY, COMFORT AND PROTECTION OF VEHICLE INTERIOR

(71) Applicant: Rachel Nguyen, Bonita Springs, FL (US)

(72) Inventor: Rachel Nguyen, Bonita Springs, FL (US)

(21) Appl. No.: 18/953,240

(22) Filed: Nov. 20, 2024

Related U.S. Application Data
(60) Provisional application No. 63/601,039, filed on Nov. 20, 2023.

(51) Int. Cl. B60N 2/60

(52) U.S. Cl. CPC B60N 2/6009; B60N 2/6027

(57) ABSTRACT

A vehicle seat mat with child car seat step-up footrest for child comfort and protection of vehicle interior is provided. The system comprises a front panel suspended from a top and back of a front seat of a motor vehicle, a lower end of the panel extending downward behind the front seat. The system also comprises a rear panel suspended from a top of a rear seat of the vehicle upon which a child car seat is positioned, the rear panel extending downward behind the child car seat and underneath the child car seat to a foot area of the child car seat. The system also comprises a rectangular footrest panel in front of the child car seat and at the foot area, the footrest connected at a first edge with a bottom of the front panel. The footrest panel connected at a second edge with bottom of rear panel.

### CROSS REFERENCE TO RELATED APPLICATIONS

The present non-provisional patent application is related to U.S. Provisional Patent Application No. 63/601,039 filed Nov. 20, 2023, the contents of which are incorporated herein in their entirety.

### FIELD OF THE DISCLOSURE

The present disclosure is in the field of child safety products. More particularly the present disclosure provides a flexible mat that a child car seat is positioned upon with the mat extending from above and behind the child car seat, to below the seat to a foot area of the child, to one side a removable footrest, and finally to a vertical sheet attaching to the other side of the footrest extending upward to attach to the top and back of the driver seat or the front passenger seat of a vehicle.

### BACKGROUND

Child car seats are an unquestioned necessity for transporting children. Sometimes called an infant safety seat, child restraint system, child seat, baby seat, car seat, or a booster seat, the child car seat is a seat designed specifically to protect children from injury or death during vehicle collisions. Most commonly these seats are purchased and installed by car owners, but car manufacturers may integrate them directly into their vehicle's design and generally are required to provide anchors and ensure seat belt compatibility. Many jurisdictions require children defined by age, weight, and/or height to use a government-approved child safety seat when riding in a vehicle. Child safety seats provide passive restraints and must be properly used to be effective. However, research indicates that many child safety restraints are often not installed or used properly.

### BRIEF SUMMARY OF THE FIGURES

FIG. 1 is a diagram of a vehicle seat mat with footrest step up feature for safety, comfort and protection of vehicle interior according to an embodiment of the present disclosure.

FIG. 2 is a diagram of a vehicle seat mat with footrest step up feature for safety, comfort and protection of vehicle interior according to an embodiment of the present disclosure.

FIG. 3a is a diagram of a vehicle seat mat with footrest step up feature for safety, comfort and protection of vehicle interior according to an embodiment of the present disclosure.

FIG. 3b is a diagram of a vehicle seat mat with footrest step up feature for safety, comfort and protection of vehicle interior according to an embodiment of the present disclosure.

### DETAILED DESCRIPTION

Systems and methods described herein provide a child car seat mat and footrest that protects the vehicle interior while providing a surface for the child's feet. The device fits behind, under, and in front of a forward-facing child car seat as the child car seat rests on a back seat of the vehicle.

A first end of the device attaches to the headrest or other top area of the seat in front of the child which may be the driver seat or the front passenger seat. A second end of the device attaches to the top of the vehicle back seat upon which the child car seat is positioned.

The second end is above and behind the child's head. From the second end above and behind the child's head to the first end, the device extends underneath the child car seat. As the device emerges from underneath the child car seat the footrest begins and becomes thicker and horizontal in position as it serves as a footrest and climbing aid for the child. From there, the device extends upward to the first end and headrest of the driver seat or front passenger seat to which the first end attaches.

The device may be provided in three component parts. The footrest, which is the smallest and thickest component, but the part that receives the most contact, may attach to front and rear portions by plastic side release clip or by zipper as is shown in the accompanying drawings.

This structure may allow the footrest to be easily detached for washing while the long front and rear portions remain in place. The device, including two clips or zippers on either side of the footrest, is strong enough to support the child's weight when climbing into or out of the child car seat. This may discourage the child from placing his shoes or feet on the vehicle's upholstery.

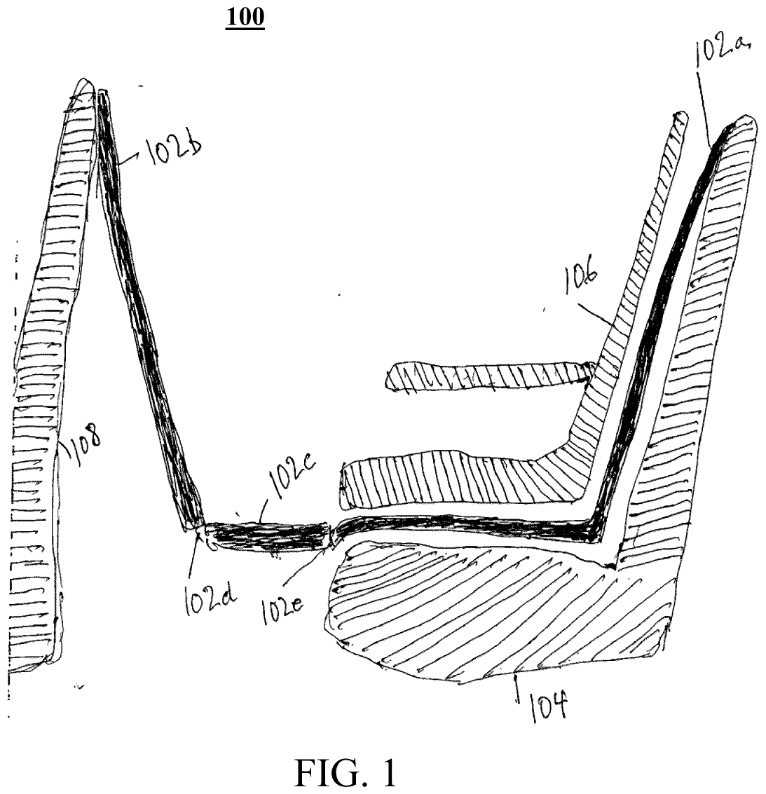

Turning to the figures, FIG. 1 is a diagram of the vehicle seat protector with footrest hosting child car seat. FIG. 1 depicts components of a system 100 of a vehicle seat mat with footrest step up feature for safety, comfort and protection of vehicle interior. System 100 comprises a seat protector 102 with its component parts 102a-e, a rear vehicle seat 104, and a child car seat 106. System 100 also comprises a vehicle front seat 108.

The seat protector 102 comprises a rear panel 102a, a front panel 102b, a footrest 102c, and side release buckles 102d-e. The rear panel 102a begins from a fastened position at the top of the rear seat 104 upon which the child car seat 106 is positioned and extends downward behind the back of the child car seat 106. The rear panel 102a upon reaching the base of the child seat 106 then proceeds underneath the child seat 106 and ends at a foot area of the child seat 106 where it connects with the footrest 102c.

The front panel 102b similarly begins at the top of the front seat 108 where it is attached. The front panel 102b extends downward to a distance about half or two thirds the way to the vehicle floor or to where it meets the footrest 102c. The front seat 108 may be the driver seat or the front passenger seat. The child car seat 106 is positioned behind the front seat 108 whether the front seat is the driver seat or the front passenger seat.

The footrest 102c is a separate physical component from the front panel 102b and the rear panel 102a and connects with those components via the side release buckles 102d-e. In an embodiment, side release buckles 102d-e may not be used and zippers may be used instead. The footrest 102c may be thicker than the panels 102a-b as an able-bodied child user of appropriate age may use the footrest 102c to climb into the child car seat 106 by placing a foot on the footrest 102c and hoisting him/herself up into the child car seat 106. This may protect the upholstery of the vehicle as the child might otherwise place his/her shoes or feet on the rear seat 104 or other upholstered area of the vehicle's interior.

The footrest 102c is removable is it more likely to become dirty and in need of washing. The components of the seat protector 102 may be made of nylon or similar material. A buckle and adjustable strap are shown for attachment of the device to the headrest of the driver or front seat.

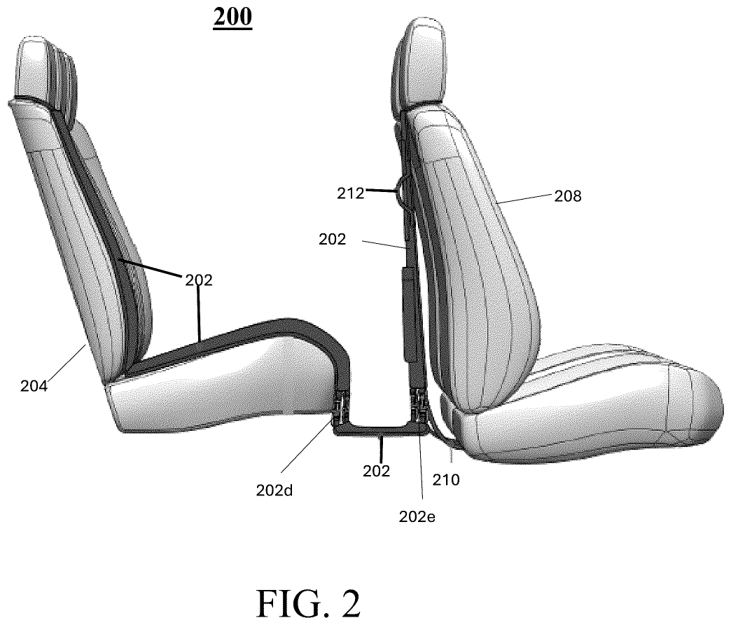

FIG. 2 is a more detailed view of the child car seat mat and footrest that protects the vehicle interior while providing a surface for the child's feet. A system 200 is provided with components that are indexed to those provided by the system 100. Several new components are also shown in FIG. 2. FIG. 2 depicts the rear panel 202a, the rear seat 204, the front panel 202b, the front seat 208, the footrest 102c, and side release buckles 202d-e.

FIG. 2 also depicts nylon handle straps 210 attached to the front panel 202b for the child to grab hold of while climbing into the child car seat which is not shown in FIG. 2. FIG. 2 further depicts elastic bungee straps 212 that hold the bottom of the front panel 202b to the back of the front seat 208. The elastic bungee straps 212 have latex coated steel hooks.

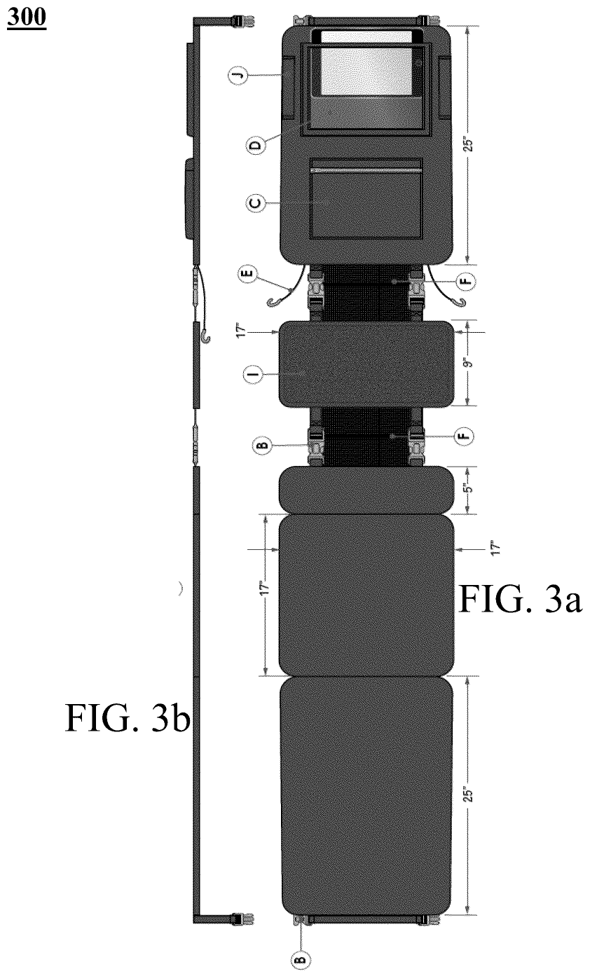

FIG. 3a presents a system 300 which provides greater detail than FIG. 1 or FIG. 2. Components of system 300 are indexed to the components of system 100. FIG. 3a is presented in landmark format instead of portrait format such that a viewer of FIG. 3a would need to rotate FIG. 3a clockwise by ninety degrees. FIG. 3a also presents its components in letter format labels instead of with numeric labels.

Component B in FIG. 3a, shown in several places, comprises side release plastic clips, both for holding the top of the rear panel to the top of the rear seat 104 and for buckling the footrest 301c to the rear panel 301a and to the front panel. Component C is a zippered storage pocket on the front panel 302b. Component D is a touchpad viewing sleeve with an acetate screen. Component E are the elastic bungee straps 212 of the system 200 and component F are nylon mesh screens that are positioned between the footrest and the panels. FIG. 3b is side view of what is shown in FIG. 3a.

In an embodiment, a system of a vehicle seat mat with child car seat step-up footrest for child comfort and protection of vehicle interior is provided. The sfcystem comprises a front panel suspended from a top and back of a front seat of a motor vehicle, a lower end of the panel extending downward behind the front seat. The system also comprises a rear panel suspended from a top of a rear seat of the vehicle upon which a child car seat is positioned, the rear panel extending downward behind the child car seat and underneath the child car seat to a foot area of the child car seat. The system also comprises a rectangular footrest panel in front of the child car seat and at the foot area, the footrest connected at a first edge with a bottom of the front panel, and the footrest panel connected at a second edge with a bottom of the rear panel.

The footrest panel attaches to the first edge and to the second edge via side release buckles. The front seat comprises one of a driver seat and a front passenger seat and wherein the child car seat is directly behind one of the driver seat and the front passenger seat.

The child car seat faces forward. The panels connect to headrest devices on front and rear seats.

In addition to providing a footrest function for a user of the child car seat, the footrest is used for a user to climb into child car seat. The availability of the footrest for supporting a user climbing into the child car seat is directed to at least protecting vehicle upholstery.

The system further comprises straps to hold the front panel in place. The footrest is constructed of rubberized and flexible material facilitating cleaning.

In another embodiment, a system for promoting child comfort and safety in a motor vehicle and protecting interior surfaces thereof is provided. The system comprises a footrest positioned at a base and foot area of a child car seat positioned on a rear seat of a motor vehicle and facing forward. The system also comprises a vertical first protective sheet attached at a first lower end to a first edge of the footrest, the first sheet connected at an upper end to a top and back of a front seat of the vehicle. The system also comprises a second protective sheet attached at a second lower end to a second edge of the footrest, wherein the second sheet extends from a top of the rear seat behind and underneath the child car seat to the second end and foot area where the second sheet meets a second edge of the footrest.

The footrest connects at the first edge and the second edge to the first lower end and the second lower end, respectively, via side release buckles. In addition to providing a footrest function for a user of the child car seat, the footrest is used for a user to climb into child car seat.

The front seat comprises one of a driver seat and a front passenger seat and wherein the child car seat is directly behind one of the driver seat and the front passenger seat. Availability of the footrest for supporting a user climbing into the child car seat is directed to at least protecting vehicle upholstery.

In yet another embodiment, a vehicle interior protection system is provided comprising a flexible mat that extends from a top of a rear seat of a motor vehicle to a top and rear of a front seat of the vehicle, the rear seat directly behind the front seat. The mat is constructed of three principal components comprising a back panel extending downward from the top of the rear seat and behind a child car seat positioned atop the rear seat and thereafter extending underneath the child car seat and ending at first endpoint at a foot area of the child car seat. The mat also comprises a front panel extending behind and downward from the top of the front seat to a second endpoint about half a distance to a floor surface of the vehicle. The mat also comprises a rectangular footrest at the foot area positioned between the first endpoint and the second endpoint.

The footrest attaches to the first endpoint and to the second endpoint via side release buckles opposite sides of the footrest. The child car seat faces forward.

In addition to providing a footrest function for a user of the child car seat, the footrest is used for a user to climb into child car seat. Availability of the footrest for supporting a user climbing into the child car seat is directed to at least protecting vehicle upholstery. The front panel optionally features a touchpad viewing sleeve with acetate screen.

What is claimed is:

1. A system of a vehicle seat mat with child car seat step-up footrest for child comfort and protection of vehicle interior, comprising:
a front panel suspended from a top and back of a front seat of a motor vehicle, a lower end of the panel extending downward behind the front seat;
a rear panel suspended from a top of a rear seat of the vehicle upon which a child car seat is positioned, the rear panel extending downward behind the child car seat and underneath the child car seat to a foot area of the child car seat; and
a rectangular footrest panel in front of the child car seat and at the foot area, the footrest connected at a first edge with a bottom of the front panel, and the footrest panel connected at a second edge with a bottom of the rear panel.

2. The system of claim 1, wherein the footrest panel attaches to the first edge and to the second edge via side release buckles.

3. The system of claim 1, wherein the front seat comprises one of a driver seat and a front passenger seat and wherein the child car seat is directly behind one of the driver seat and the front passenger seat.

4. The system of claim 1, wherein the child car seat faces forward.

5. The system of claim 1, wherein the panels connect to headrest devices on front and rear seats.

6. The system of claim 1, wherein in addition to providing a footrest function for a user of the child car seat, the footrest is used for a user to climb into child car seat.

7. The system of claim 6, wherein the availability of the footrest for supporting a user climbing into the child car seat is directed to at least protecting vehicle upholstery.

8. The system of claim 1, wherein the system further comprises straps to hold the front panel in place.

9. The system of claim 1, wherein the footrest is constructed of rubberized and flexible material facilitating cleaning.

10. A system for promoting child comfort and safety in a motor vehicle and protecting interior surfaces thereof, comprising:
a footrest positioned at a base and foot area of a child car seat positioned on a rear seat of a motor vehicle and facing forward;
a vertical first protective sheet attached at a first lower end to a first edge of the footrest, the first sheet connected at an upper end to a top and back of a front seat of the vehicle;
a second protective sheet attached at a second lower end to a second edge of the footrest, wherein the second sheet extends from a top of the rear seat behind and underneath the child car seat to the second end and foot area where the second sheet meets a second edge of the footrest.

11. The system of claim 10, wherein the footrest connects at the first edge and the second edge to the first lower end and the second lower end, respectively, via side release buckles.

12. The system of claim 10, wherein in addition to providing a footrest function for a user of the child car seat, the footrest is used for a user to climb into child car seat.

13. The system of claim 10, wherein the front seat comprises one of a driver seat and a front passenger seat and wherein the child car seat is directly behind one of the driver seat and the front passenger seat.

14. The system of claim 10, wherein availability of the footrest for supporting a user climbing into the child car seat is directed to at least protecting vehicle upholstery.

15. A vehicle interior protection system, comprising:
a flexible mat that extends from a top of a rear seat of a motor vehicle to a top and rear of a front seat of the vehicle, the rear seat directly behind the front seat, the mat constructed of three principal components comprising:
a back panel extending downward from the top of the rear seat and behind a child car seat positioned atop the rear seat and thereafter extending underneath the child car seat and ending at first endpoint at a foot area of the child car seat,
a front panel extending behind and downward from the top of the front seat to a second endpoint about half a distance to a floor surface of the vehicle, and
a rectangular footrest at the foot area positioned between the first endpoint and the second endpoint.

16. The system of claim 15, wherein the footrest attaches to the first endpoint and to the second endpoint via side release buckles opposite sides of the footrest.

17. The system of claim 15, wherein the child car seat faces forward.

18. The system of claim 15, wherein in addition to providing a footrest function for a user of the child car seat, the footrest is used for a user to climb into child car seat.

19. The system of claim 15, wherein availability of the footrest for supporting a user climbing into the child car seat is directed to at least protecting vehicle upholstery.

20. The system of claim 15, wherein the front panel optionally features a touchpad viewing sleeve with acetate screen.
